(19) United States
(12) Patent Application Publication
(10) Pub. No.: US 2006/0163393 A1
(43) Pub. Date: Jul. 27, 2006

(54) Apparatus and method for automatically defibering and extracting kraft pulp from old corrugated cardboard

(76) Inventor: Sun-Ho Chung, Cheonan-Si (KR)

Correspondence Address: MAYER, BROWN, ROWE & MAW LLP, 1909 K STREET, N.W., WASHINGTON, DC, 20006, US

(21) Appl. No.: 10/526,357

(22) PCT Filed: Sep. 2, 2002
(86) PCT No.: PCT/KR02/01655

§ 371 Date: Mar. 2, 2005

(51) Int. Cl. B02C 23/36

(52) U.S. Cl. 241/21; 241/46.17

(57) ABSTRACT

The present invention relates to an apparatus and method for automatically defibering and extracting kraft pulp from old corrugated cardboards. The apparatus includes a) a pulper (1) for crushing, separating and defibering old corrugated cardboards using white water; b) a first means for continuously detecting defibering states of old corrugated cardboard pieces and outputting detected data; c) a second means for selectively exhausting defibered corrugated medium and linerboard from the pulper; d) a third means for respectively estimating first and second target values indicative of defibering states of corrugated medium and linerboard pieces defibered in the pulper (1); and a fourth means for controlling the second means to exhaust defibered corrugated medium and linerboard from the pulper (1) by comparing the detected data with the estimated first and second target values respectively. The first means has a comparative consistency meter (5) and the apparatus further includes a level meter (4) to detect the level of the white water in the pulper (1).

### TECHNICAL FIELD

The present invention relates to an apparatus and method for recycling Kraft pulp by extracting linerboard from old (waste) corrugated cardboards, and more particularly, to an apparatus and method for effectively extracting unbleached Kraft pulp of long fibers which form the linerboard in the old corrugated cardboards.

### BACKGROUND

Generally, the corrugated cardboard is composed of the corrugated medium of short fibers and the linerboards of long fibers in order to keep the contents therein from an external shock and to distribute them safely. The corrugated cardboards have been used as an external cases these days. Particularly, the rate of the long fibers in the linerboard is a factor to determine a commercial value of the corrugated cardboards and they are evaluated according to the rate of the long fibers. The strength of the linerboard should be maintained in a predetermined rage to safely keep the contents therein and then it is very important to effectively extract the long fibers in recycling the corrugated cardboards because the strength of the linerboards is determined by the rate of the long fibers.

Further, the linerboards to be used in the corrugated cardboards can come from virgin Kraft pulp, but they have been recycled from the old corrugated cardboards because of the protection of natural and a cost-saving policy. Since the conventional method for recycling the linerboards does not systematically classify the corrugated cardboard into the long fibers and the short fiber, this has the following drawbacks first, the rate of the long fibers is decreased because the corrugated medium consisting of short fibers is mixed into the defibered linerboards. Second, the rate of long fibers to determine the quality of the recycled Kraft pulp is reduced because the unbleached Kraft pulp (UKP) of the long fibers are removed together with contaminants which are treated by various cleaners required to recycle the old corrugated cardboards. Third, although it is possible to reject the short fibers, the short fibers, which are mixed into the defibered linerboard, are not easily extracted because of the limitations of a fractionator. Fourth, fibrils, which come from the initial pulping process of the old corrugated cardboard, may be defibered again, thereby forming micro-fibrils and decreasing the effective hydrogen bond area, so that it is impossible to achieve the strength demanded in market without any virgin UKP.

Particularly, since a conventional fractionator fractionates the recycled pulp by a pressure screen having a plurality of openings with fixed apertures, the long and short fibers are mixed each other and then they get tangled. Accordingly, the long fibers can be screened with the short fibers so that the selective screen of the long or short fibers is not easy.

To solve the above problem, in another conventional technique, a plurality of fractionators, which are in series arranged, have been used. However, it is hard to obtain the rate of the long fibers that are required to increase the tensile strength of the linerboards. Accordingly, a costly virgin UKP must be required to achieve the high strength linerboard. In recycling the old corrugated cardboards, the pressure screen, such as a fine screen, is inevitably required to remove the contaminants and the UKP is also removed with the contaminants by the pressure screen so that the rate of the long fibers is further decreased. A refiner has been also used to improve the quality of the recycled pulp but this refiner detaches the fibrils from the fiber body and then decreases the effective hydrogen bond area between cellulose which makes a dominant cause to deteriorate the tensile strength of the recycled pulp.

Another method to solve the problem is disclosed in U.S. Pat. No. 6,340,407, which was filed by the same inventor as the present invention, explaining the manual dual batch type.

However, in the pulper for crushing, separating and defibering old corrugated cardboards in this manual dual batch type, an operator should exhaust the defibered corrugated medium after observing a degree of the defibering thereof using his eye and thereafter agents to accelerate the defibering of the linerboard are put into the pulper and the defibered linerboards are exhausted. Accordingly, the operator should continuously make an observation of the defibering state of the corrugated medium in the pulper. In case where the old corrugated cardboards are crushed and separated in a mass pulper, the quality of the recycled linerboards (that is, the rate of unbleached Kraft pulp) deteriorates because the operator can not exactly observe the inner state of the mass pulper and he takes a subjective view of the defibering state of the old corrugated cardboards.

### SUMMARY OF THE INVENTION

To solve the problem, an object of the present invention is to provide an apparatus and method for recycling Kraft pulp by automatically defibering corrugated medium and linerboards from old corrugated cardboards under the control of a central processing unit or such a system.

Another, object of the present invention is to provide an apparatus and method for effectively and massively extracting unbleached Kraft pulp of good quality that is included in the linerboard of old corrugated cardboards.

According to an aspect of the present invention, there is provided a method for defibering and extracting kraft pulp from old corrugated cardboards, the method comprising the steps of: providing old corrugated cardboards and a first predetermined amount of white water for a pulper and crushing, separating and defibering the old corrugated cardboards; detecting a defibering state of old corrugated cardboard pieces; exhausting a short fiber suspension when the defibering state of the old corrugated cardboard pieces reaches to a first target value; providing a second predetermined amount of white water for the pulper and crushing, separating and defibering the remaining old corrugated cardboard pieces, and detecting a defibering state of the remaining old corrugated cardboard pieces; and exhausting a long fiber suspension when the defibering state of the remaining old corrugated cardboard pieces reach to a second target value.

### BRIEF DESCRIPTION OF THE DRAWING

FIG. 1 is a flow chart illustrating separation and defibering processes of the old corrugated cardboards in accordance with the present invention;

FIG. 2 is a schematic diagram illustrating a pulping system to separate and defiber old corrugated cardboards in accordance with an embodiment of the present invention;

FIG. 3 is a schematic diagram illustrating a pulping system to separate and defiber old corrugated cardboards in accordance with another embodiment of the present invention; and

FIG. 4 is a detailed perspective view illustrating a nozzle at an end of the white water pipe in accordance with the present invention.

### PREFERRED EMBODIMENT

Hereinafter, an apparatus and method for recycling Kraft pulp according to the present invention will be described below.

The present invention takes advantage of a fact that corrugated medium of short fibers is first defibered and thereafter linerboards of long fibers are defibered when a separating and defibering pulper receiving white water and old corrugated cardboards crushes the old corrugated cardboards and defibers them in the white water, whereby the short and long fibers are effectively separated. That is, the defibered corrugated medium of short fiber is firstly stored in a corrugated medium chest by an extracting process of the corrugated medium from the old corrugated cardboards at the time the corrugated medium is substantially defibered in the separating and defibering pulper (hereinafter, referred to as “pulper”). After extracting the corrugated medium, defibered linerboards of long fiber are stored in a linerboard chest by an extracting process of the defibered linerboard suspension from the corrugated cardboards at the time that is substantially defibered in the separating and defibering pulper. By extracting the defibered linerboards effectively, the unbleached Kraft pulp is recycled by using only the stored linerboards in the linerboard chest.

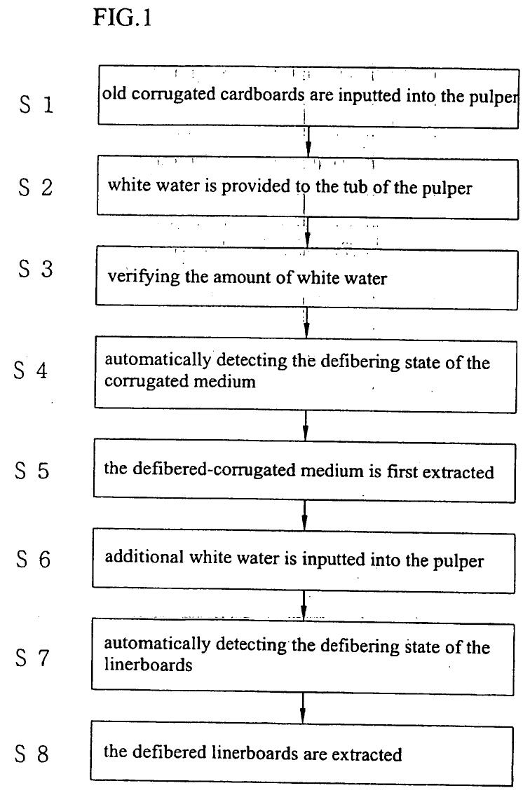

Referring to FIG. 1 illustrating separation and defibering processes of the old corrugated cardboards in accordance with the present invention, old corrugated cardboards are inputted into the pulper at step S1 and a predetermined amount of white water, which corresponds to the inputted corrugated cardboards, is provided to the tub of the pulper at step S2. The present invention verifies whether the calculated amount of white water is exactly provided for the pulper or not, based on a flow rate of a white water injection pipe at step S3. At this time, to take a little input time, some of the white water can be previously inputted into the pulper at the earlier step and further the white water can be added to the pulper until it reaches to a target level in the pulper.

At step S4, with the continuous defibering processes to rotate a motor in the pulper for which the white water is provided, the corrugated medium of the short fibers is first defibered. Therefore, the pulper according to the present invention detects a state that the corrugated medium is fully defibered at step S4 and the defibered-corrugated medium is first extracted at step S5.

Subsequently, additional white water, which is required to defiber the linerboards in the old corrugated cardboard, is inputted into the pulper at step S6. At this time, it is available to add agents in the pulper together with the white water to accelerate the defibering of the linerboards. A state of the defibering of the linerboards is automatically detected with the continuous defibering process of the linerboards at step S7 and the defibered linerboards extracted at step S8 are used for recycling the Kraft paper.

In the preferred embodiment of the present invention, the full defibering states of the corrugated medium and linerboards of the old corrugated cardboards are automatically detected by measuring a consistency of the white water in the pulper. In other words, a first target value, which is the consistency obtained when the corrugated medium is fully defibered in a previously executed experiment based on the weight of the old corrugated cardboards and the white water, is compared with a current consistency value. After inputting the white water, the defibering state of the corrugated medium is continuously detected using a consistency meter. If the measured consistency of the white water reaches to the first target value, the pulping system controlled by a central processing unit assumes that the corrugated medium is fully defibered and extracts the fiber suspension of the corrugated medium.

After extracting the corrugated medium, additional white water is inputted into the pulper. In such a same manner, a second target value, which is the consistency obtained when the linerboards fully are defibered in a previously executed experiment based on the weight of the remaining linerboards and the white water, is compared with a current consistency value. After injecting the white water, the defibering state of the linerboards is continuously detected using a consistency meter. If the measured consistency of the white water reaches to the second target value, the pulping system controlled by a central processing unit assumes that the linerboards are fully defibered and extracts the defibered linerboards.

Also, in another embodiment of the present invention, it is possible to adapt a method for automatically measuring defibering time of the corrugated medium and the linerboards within the old corrugated cardboards.

In this embodiment, a first target level is set up as time value based on the weight of the input amount of the old corrugated cardboard and white water established by experimental data and simulation and then the defibered corrugated medium is automatically exhausted in case that the time the defibering process of the corrugated medium is conducted is the same as the first target level. Also, a second target level is set up as the time value based on the weight of the input amount of the linerboards and white water established by experimental data and simulation, the defibering process is executed for a period of the time corresponding to the second target level, and then the secondary exhaustion of the linerboards is carried out.

Further, it would have been obvious to a person having ordinary skill in the art to which the subject pertains that the method for estimating a defibering state of the old corrugated cardboard in order to automatically extract the defibered corrugated medium and the linerboards, respectively, can be modified without departing from the scope of the claimed invention.

On the other hand, the white water's level in the pulper and/or the flow rate thereof can be used in determining a point of time of extracting the corrugated medium or the linerboards. If particles or contaminations are contained in the provided old corrugated cardboards, a plate having a plurality of, apertures, which is formed in the front end of the exhausting apertures of the pulper, is choked up with such the particles or contaminations and then it is hard to smoothly exhaust the white water. In this case, since the level of the white water in the pulper can be measured below a current value or at a continuously constant value after the exhaustion process is carried out for a predetermined time, a controller should detects the white water's level and/or the flow rate thereof to take follow-up measures.

Accordingly, to implement an automatic double hatch process, the present invention automatically decides the defibering time of the corrugated medium and the linerboards based on the experimentally established defibering time. Being different from the conventional pulping systems, the defibered-corrugated medium is first exhausted and, thereafter, the defibered linerboards are exhausted based on the experimentally established defibering time.

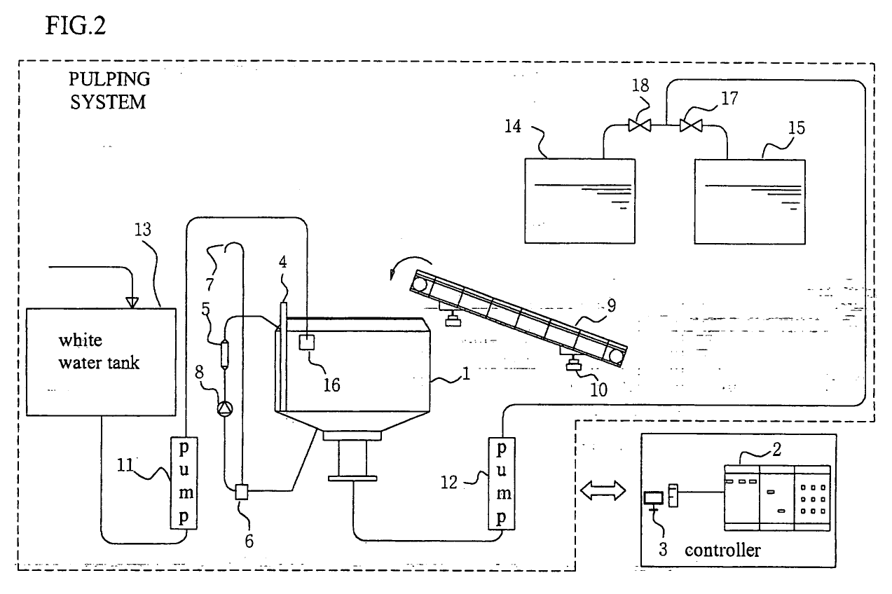

Referring to FIG. 2, an apparatus for automatically recycling Kraft pulp according to an embodiment of the present invention includes: a pulper 1 to crush, separate and defiber the old corrugated cardboards; a conveyer 9 having a load cell 10; a level meter 4 to measuring the level of the white water in the pulper; a circulation pump 8; a consistency meter 5; a suction strainer 6; an air vent 7; a machine control circuits panel 2; a white pump 11; a stock pump 12; valves 17 and 18; and a computer 3 for automatically controlling these parts.

The old corrugated cardboards are provided into the pulper 1 via the conveyer 9. At this time, the load cell 10 in the conveyer 9 measures the weight of the provided corrugated cardboards and transmits the weight data to the machine control circuits panel 2 and the computer makes a decision of an amount of white water to be inputted into the pulper 1 based on the measured weight of the provided corrugated cardboards and actuates the white water pump 1 to provide the white water into the pulper 1.

Alternatively, to shorten the time of providing the white water, a predetermined amount of the white water can be previously inputted into the pulper before or during the input of the old corrugated cardboards and this additional white water can be provided until the level of the white water reaches a target value in the pulper.

When the white water is inputted, the old corrugated cardboards are crushed by a rotor motor which is continuously rotated in the pulper 1. The old corrugated cardboards are broken into bits and the corrugated medium within the crushed corrugated cardboards first absorbs the white water, i.e., the absorptivity of the corrugated medium is faster than the linerboards. At this time, an adhesive agent is simultaneously melted so that the corrugated medium is detached from the linerboards by a force of shaking the white water and the old corrugated cardboards in the pulper.

The linerboards that absorb the white water latter float on the white water, but the corrugated medium sinks to the bottom of the pulper 1 since the specific gravity of the corrugated medium is higher than that of the linerboards. The corrugated medium, which sinks to the bottom of the pulper, is easily defibered by the powerful rotation of the motor, thereby increasing the consistency of the white water (defibered corrugated medium) within the pulper 1.

The consistency meter 5 consecutively detects the consistency of the white water including the fiber suspension in the pulper, by circulating the white water using the circulation pump 8 within the pulper and sucking the white water from the bottom of the pulper 1 through the suction strainer 6. The air vent 7 is connected to the suction strainer 6 to exhaust air from the white water passing through the circulation pump 8. The air vent 7 is set up above the level of the white water.

The data obtained by the consistency detection are transmitted to the computer 3 via the machine control circuit panel 2 and the computer 3 receives the weight data of the old corrugated cardboards which are detected by the load cell 10 and the level information of the white water from the level meter 4. The computer 3 makes a decision of the time the defibering process of the corrugated medium has been completed, by comparing the consistency value inputted from the consistency meter 5 with a target value established by the experimental data.

When the computer 3 decides that the defibering of the corrugated medium has been completed, the stock pump 12 to exhaust the defibered corrugated medium immediately works and the valve 17 toward a medium stock chest 15 is opened to exhaust the defibered corrugated medium. The time the defibering of the corrugated medium has been completed is decided based on the white water level data from the level meter 4 and the white pump 11 works to provide the white water required to defiber the linerboards immediately after such a decision. Upon occasions, an agent to expedite the defibering of the linerboards can be used.

Likewise, the circulation pump 8 continuously circulates the white water in the pulper 1 without interruption in order that the white water continuously passes through the consistency meter 5 and then the consistency of the defibered linerboard is continuously detected by the consistency meter 5 which is disposed outside the pulper 1. When the value detected by the consistency meter 5 is the same as the target value stored in the computer 3, the stock pump 12 operates and the defibered linerboards are exhausted toward the liner stock chest 14 via the valve 18.

On the other hand, in the defibering processes of the corrugated medium and linerboards, if the level meter 4 indicates a level of the white water after the exhaustion time of the defibered suspension has been completed, the valves 17 and 18 are closed with the stop of the stock pump 12 and a subsequent process, such as a contaminant cleaning step, is carried out, thereby achieving the dual batch process of the present invention.

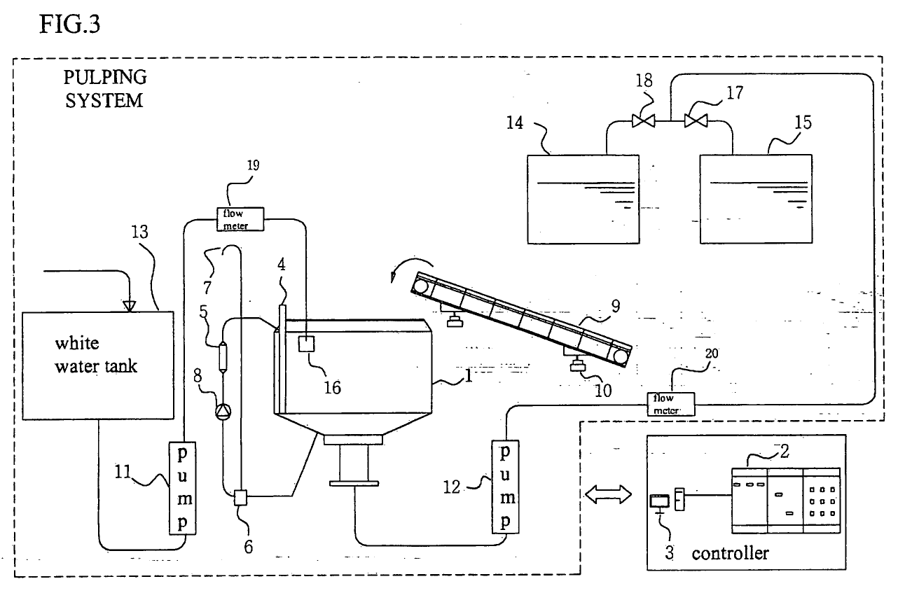

Another embodiment of the present invention is shown in FIG. 3. An apparatus for automatically recycling Kraft pulp in FIG. 3 is substantially the same as that in FIG. 2 except that first and second, flow meters 19 and 20, instead of the level meter 4, are provided for the pulping system. The amount of white water inputted in the pulper 1 and the amount of white water exhausted from the pulper 1 are exactly detected, by evaluating the amount of white water provided in the pulper 1 via the first flow meter 19 and the amount of white water exhausted from the pulper 1 via the second flow meter 20, as if the level meter 4 in FIG. 2 detects the input and output amount of white water.

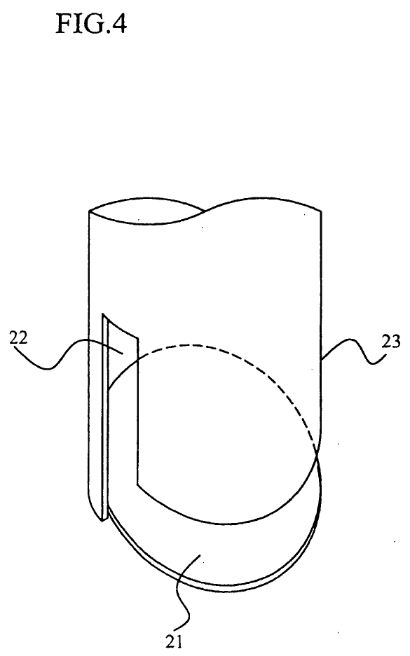

FIG. 4 is a detailed perspective view illustrating a nozzle at an end of the white water pipe to provide the white water for the pulper 1 in accordance with the present invention. The nozzle has, a structure capable of spouting out the white water to the provided corrugated cardboards with the rotation of the white water. That is, a bottom plate 21 is disposed at an outlet 23 of the white water pipe in order that the white water is spouted between the outlet 23 and the bottom plate 21. Also, a slit 22 is upwardly formed at a side of the outlet 23 so that the white water is laterally spouted on the old corrugated cardboards by the bottom plate 21 and the slit 23. By the lateral spout from the outlet 23 of the white water pipe, the white water rotates the floated cardboards on the white water in the pulper. A portion of the bottom plate 21 is fixed to the outlet 23 and this tilts downwardly to the floated cardboards. The slit 22, which is upwardly, formed at a side of the outlet 23, prevents the siphon phenomena and makes the white water rotate in the pulper 1.

On the other hand, to improve the productivity of the pulper 1 in a preferred embodiment of the present invention, the input of the corrugated cardboards and the capacities of the white water pump 11 and the stock pump 12 can be increased. However, in the conventional dual batch type worked by hand, since the control of the white water and the evaluation of the defibering of the corrugated medium and linerboards are dependent only on the operator, it is subject to restrictions on the exact controls of the required amount of the white water and the evaluation of the defibering.

Therefore, it is very difficult to increase the input amount of the old corrugated cardboards and the white water in order to improve the productivity of the pulper in the conventional manual dual batch type without increasing the capacity of the pulper; however, this problem is to be solved in the present invention using the automatic dual batch type because an automatic control unit is used. Therefore, the present invention has an advantage of the productivity of the pulper because the input amount of the old corrugated cardboards and the white water can be increased and the output amount of the exhaustion of the defibered suspension is also increased.

### INDUSTRIAL APPLICABILITY

As apparent from the above, the present invention has an effect on an improvement in the productivity of the pulping system to produce the recycled high-stronger Kraft pulp (or linerboards) so that the present invention can substitute the recycled unbleached Kraft pulp from the old corrugated cardboards for the expensive virgin unbleached Kraft pulp. Accordingly, compared the conventional manual batch type, the present invention improves the productivity of the Kraft pulp recycle and the mass production processes.

1. A method for defibering and extracting kraft pulp from old corrugated cardboards, the method comprising the steps of:
providing old corrugated cardboards and a first predetermined amount of white water for a pulper and crushing, separating and defibering the old corrugated cardboards;
detecting a defibering state of old corrugated cardboard pieces;
exhausting a short fiber suspension when the defibering state of the old corrugated cardboard pieces reaches to a first target value;
providing a second predetermined amount of white water for the pulper and crushing, separating and defibering the remaining old corrugated cardboard pieces, and detecting a defibering state of the remaining old corrugated cardboard pieces; and
exhausting a long fiber suspension when the defibering state of the remaining old corrugated cardboard pieces reach to a second target value.

2. The method as recited in claim 1, further comprising the step of determining an amount of the white water based on weight of the provided old corrugated cardboards.

3. The method as recited in claim 2, wherein the first target value is a consistency of the short fiber suspension in the pulper and is established by the weight of the old corrugated cardboards and the white water.

4. The method as recited in claim 2, wherein the first target value is defibering time of the short fiber suspension in the pulper and is established by the weight of the old corrugated cardboards and the white water.

5. The method as recited in claim 3, wherein the second target value is a consistency of the long fiber suspension in the pulper and is established by the weight of the old corrugated cardboards and the white water.

6. The method as recited in claim 4, wherein the second target value is defibering time of the long fiber suspension in the pulper and is established by the weight of the old corrugated cardboards and the white water.

7. The method as recited in claim 1, wherein the first and second predetermined amounts of white water are respectively decided by a level meter to measure a level of the white water in the pulper.

8. The method as recited in claim 1, wherein the first and second predetermined amounts of white water are decided by flow meters to measure an input amount of the white water to the pulper and an output amount of the white water from the pulper, respectively.

9. The method as recited in claim 1, wherein the white water is provided for the pulper to makes the white water rotate.

10. An apparatus for defibering and extracting kraft pulp from old corrugated cardboards comprising:
a pulper for crushing, separating and defibering old corrugated cardboards using white water;
detecting means for detecting defibering states of old corrugated cardboard pieces and outputting detected data;
exhausting means for selectively exhausting short and long fiber suspensions from the pulper; and
control means for storing a first target value indicative of a defibering sate of the short fiber suspension of the old corrugated cardboard pieces and a second target value indicative of a defibering sate of the long fiber suspension of the old corrugated cardboard pieces, comparing the detected data from the detecting means with the first and second target values; and controlling the exhausting means in order to selectively exhaust the short and long fibers from the pulper.

11. The apparatus as recited in claim 10, wherein the detecting means is a consistency detecting means to detect a consistency of the short and long fiber suspensions.

12. The apparatus as recited in claim 11, wherein the consistency detector comprises:
a suction strainer for extracting the short and long fiber suspensions from the pulper;
a circulation pump for circulating the extracted short and long fiber suspension from the suction strainer to the pulper;
a consistency detector disposed between the pulper and the circulation pump for detecting consistency of the short and long fiber suspensions.

13. The apparatus as recited in claim 11, further comprising a level meter for measuring a level of the white water in the pulper.

14. The apparatus as recited in claim 11, further comprising means for detecting an amount of the white water in the pulper and wherein the means comprises:
a first flow meter provided to a white water pipe in order to measure an amount of the white water provided to the pulper; and
a second flow meter provided to the exhausting means in order to measure an amount of the white water exhausted from the pulper.

15. The apparatus as recited in claim 10, further comprising:
a conveyer for providing the old corrugated cardboards to the pulper; and
a weight detecting means for detecting weight of the old corrugated cardboards.

16. The apparatus as recited in claim 11, wherein the exhausting means comprises:
a pump for exhausting the short and long fiber suspensions in the pulper;
first and second chests for containing the short and long fiber suspensions, respectively;
first and second valves respectively provided to inlets of the first and second chests.

17. The apparatus as recited in claim 11, wherein the first target value is a consistency of the short fiber suspension in the pulper and is established by the weight of the old corrugated cardboards and the white water.

18. The apparatus as recited in claim 10, wherein the first target value is defibering time of the short fiber suspension in the pulper and is established by the weight of the old corrugated cardboards and the white water.

19. The apparatus as recited in claim 17, wherein the second target value is a consistency of the short fiber suspension in the pulper and is established by the weight of the old corrugated cardboards and the white water.

20. The apparatus as recited in claim 18, wherein the second target value is defibering time of the short fiber suspension in the pulper and is established by the weight of the old corrugated cardboards and the white water.

21. The apparatus as recited in claim 14, wherein the white water pipe comprises:
a bottom plate blocking a portion of an outlet thereof, being tilted; and
a slit upwardly formed at a side of the outlet.
